(19) United States
(12) Patent Application Publication
(10) Pub. No.: US 2026/0203651 A1
(43) Pub. Date: Jul. 16, 2026

(54) BLOCKCHAIN-SECURED MACHINE LEARNING MODEL MANAGEMENT

(71) Applicant: Renesas Electronics Corporation, Tokyo (JP)

(72) Inventor: Shashank BANGALORE LAKSHMAN, Folsom, CA (US)

(73) Assignee: Renesas Electronics Corporation, Tokyo (JP)

(21) Appl. No.: 19/023,057

(22) Filed: Jan. 15, 2025

(51) Int. Cl. G06N 20/00

(52) U.S. Cl. CPC G06N 20/00

(57) ABSTRACT

Systems and methods for implementing blockchain-secured machine learning model management are described. The system can include a Machine Learning Operations (MLOps) user interface (UI), an MLOps processor, a model operation tool stack, and a model registry. The MLOps UI is configured to allow a user to interact with the system and receive a request for operating a machine learning model. The request includes a model transaction and blockchain ledger. The MLOps processor is communicatively connected to the MLOps UI. The MLOps processor is configured to manage the machine learning model and to execute workflows associated with the model transaction. The model operation tool stack is configured to perform tasks for operating the machine learning model. The model storage is configured to store encrypted machine-learning models. The model registry is configured to manage the machine learning model and the model transaction using the blockchain ledger.

### BACKGROUND

The present disclosure relates in general to machine learning model management. More specifically, the present disclosure relates to blockchain-secured machine learning model management.

Blockchain technology, widely recognized for its significant role in the cryptocurrency industry, offers convenient and secure transactions in various applications. Its inherent properties of immutability, decentralization, and transparency make it well-suited to address challenges in managing sensitive and proprietary data. Organizations operating in the AI domain often employ Machine Learning Operations (MLOps) platforms to streamline the development, deployment, and monitoring of machine learning models. By integrating MLOps technology into the blockchain, it is possible to create a secure system that tracks and verifies transaction histories without risk of tampering or unauthorized access.

### SUMMARY

In an aspect, a system for implementing blockchain-secured machine learning model management is generally described. The system can include a Machine Learning Operations (MLOps) user interface (UI), an MLOps processor, a model operation tool stack and a model registry. The MLOps UI is configured to allow a user to interact with the system and receive a request for operating a machine learning model. The request comprises a model transaction and blockchain ledger. The MLOps processor is communicatively connected to the MLOps UI. The MLOps processor is configured to manage the machine learning model and to execute workflows associated with the model transaction. The model operation tool stack is communicatively connected to the MLOps processor. The model operation tool stack is configured to perform tasks for operating the machine learning model. The model storage is communicatively connected to the model operation tool stack. The model storage is configured to store encrypted machine-learning models. The model registry is configured to manage the machine learning model and the model transaction using the blockchain ledger.

In an aspect, a system for implementing blockchain-secured machine learning model management is generally described. The system can include a MLOps UI, a model transaction processor, a consensus mechanism, a model registry, and a model operation component. The MLOps UI is configured to allow a user to interact with the system and receive a request for operating a machine learning model. The request comprises a model transaction and blockchain ledger associated with the machine learning model. The MLOps is further configured to provide an encrypted workload based on the request for operating the machine learning model. The model transaction processor is communicatively connected to the UI. The model transaction processor is configured to verify the encrypted workload based on a model public key to generate a verified encrypted model. The model transaction processor is further configured to create a block for the model transaction using a model secret key to provide a created block. The consensus mechanism is configured to broadcast the created block to a plurality of nodes in a permissioned blockchain network. The consensus mechanism is further configured to collect validation responses regarding the model transaction from the plurality of nodes. The consensus mechanism is further configured to determine a consensus result based on the validation responses. The model registry is communicatively connected to the consensus mechanism. The model registry is configured to manage the machine learning model and the model transaction using the blockchain ledger. The model storage is communicatively connected to the model registry. the model storage is configured to store the machine learning models in an encrypted format.

In an aspect, a method for implementing blockchain-secured machine learning model management is generally described. The method can include receiving, via a MLOps UI, a request for operating a machine learning model. The request comprises a model transaction and blockchain ledger associated with the machine learning model. The method can further include encrypting the request using a model public key to generate an encrypted workload. The method can further include transmitting the encrypted workload to a model transaction processor. The method can further include verifying, by the model transaction processor, the encrypted workload to generate a verified encrypted model transaction. The method can further include creating a block based on the verified encrypted model transaction to provide an updated encrypted blockchain ledger. The method can further include sending the updated encrypted blockchain ledger and a user public key with a plurality of nodes in a permissioned blockchain network. The method can further include receiving a plurality of validation responses from the plurality of nodes, each validation response indicating an acceptance or a rejection of the model transaction. The method can further include performing a consensus procedure based on the plurality of validation responses to determine a consensus result. The method can further include updating the blockchain ledger based on the consensus result and broadcasting the updated blockchain ledger to the plurality of nodes in the permissioned blockchain network.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram showing a scenario where multiple users interact with an example system for implementing blockchain-secured machine learning model management according to an illustrative embodiment.

FIG. 2 is a diagram showing an example scenario for implementing blockchain-secured machine learning model management according to an illustrative embodiment.

FIG. 3A and FIG. 3B illustrate one or more processes for implementing blockchain-secured machine learning model management according to an illustrative embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, conventional structures or processing steps have not been described in detail in order to avoid obscuring the present application.

The rapid advancement of machine learning and artificial intelligence (AI) has led to the proliferation of Deep Neural Network (DNN) models in various applications. As organizations increasingly adopt DNN models, ensuring secure and transparent management of these models has become necessary, particularly for proprietary or customer-provided models.

Organizations operating in the AI domain often employ MLOps processors to streamline the development, deployment, and monitoring of machine learning models. However, existing MLOps systems lack robust mechanisms to ensure the security and traceability of customer-submitted models in a cloud-based infrastructure. These models are considered sensitive intellectual property, and any unauthorized access or tampering can result in significant breaches of trust and potential economic losses.

One challenge is the inability to track and verify all interactions with a DNN model across its lifecycle within an MLOps processor. Current practices primarily focus on securing model data using encryption, but they do not provide comprehensive visibility into the “who” and “what” of interactions with the models. Moreover, conventional solutions cannot reliably demonstrate the integrity of transaction histories, which is useful for maintaining transparency and ensuring compliance with governance policies.

Blockchain technology, widely recognized for its role in securing cryptocurrency transactions, offers a potential solution. Its inherent properties of immutability, decentralization, and transparency make it well-suited to address challenges in managing sensitive and proprietary data. By integrating blockchain technology into an MLOps processor, it is possible to create a secure and transparent system that protects proprietary DNN models, tracks all interactions, and verifies transaction histories without risk of tampering or unauthorized access.

This disclosure introduces a “Bring Your Own Model (BYOM)” system for MLOps processors, incorporating a private permissioned blockchain to secure and manage customer-provided DNN models. By treating every interaction with the model—whether accessing, modifying, or registering—as a transaction recorded on a decentralized ledger, this system ensures full traceability and governance over the model lifecycle. This approach represents a significant advancement in the secure management of AI models and addresses critical gaps in current practices.

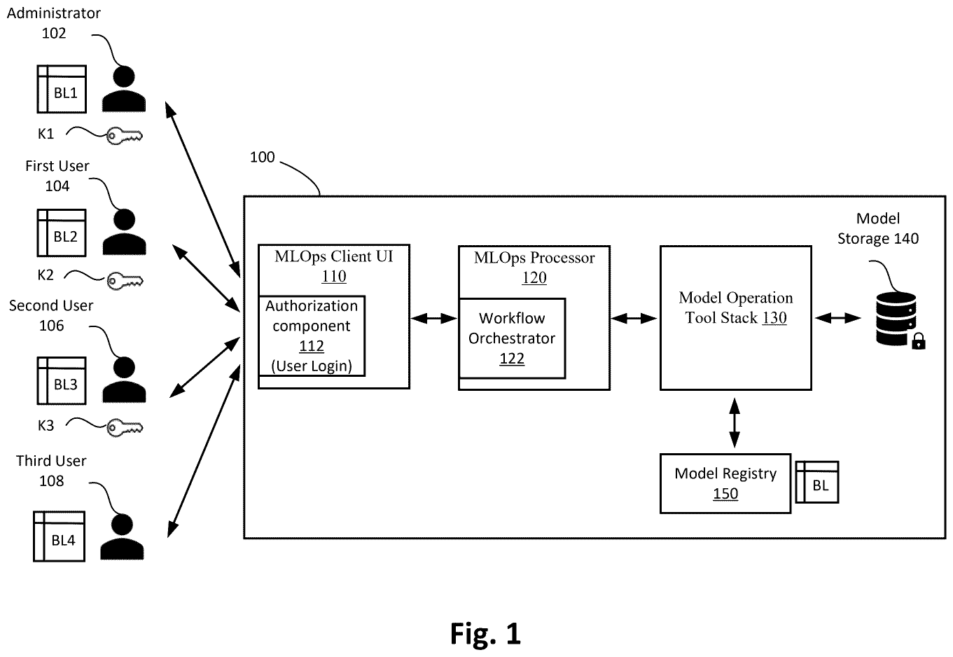

FIG. 1 is a diagram showing a scenario where multiple users interact with an example system 100 for implementing blockchain-secured machine learning operations in machine learning model management according to an illustrative embodiment. As shown in FIG. 1, in this scenario, there are multiple users, for example, an administrator 102, a first user 104, a second user 106, and a third user 108. Note that there can be more or fewer users in the scenario, and the number of users is for illustration purposes rather than limiting this disclosure. The system 100 can include an MLOps UI 110, an MLOps processor 120, a model operation tool stack 130, a model storage 140, and a model registry 150.

The administrator 102 can be associated with a first blockchain ledger BL1 and a first key K1. The first user 104 can be associated with a second blockchain ledger BL2 and a second key K2. The second user 106 can be associated with a third blockchain ledger BL3 and a third key K3. The third user 108 can be associated with a fourth blockchain ledger BL4.

The MLOps UI 110 is configured to be the interface through which users (e.g., the administrator 102, the first user 104, the second user 106, and the third user 108) interact with the system 100. The MLOps UI 110 can provide a UI for a user to interact with the system 100. The UI can receive a request for operating a machine learning model from the user. The request comprises a model transaction and blockchain ledger associated with the machine learning model.

The MLOps UI 110 can include an authorization component 112 configured to verify user identities through a login process. Each user (e.g., the administrator 102, the first user 104, the second user 106, and the third user 108) can be authenticated by the authorization component 112 such that only authorized individuals can access the system 100. After successful authorization, the MLOps UI 110 can serve as the gateway for initiating workflows managed by the MLOps processor 120.

The MLOps processor 120 can communicate with the MLOps UI 110. The MLOps processor 120 is configured to manage the lifecycle of machine learning models. For instance, the machine learning models can be DNN models. The MLOps processor 120 can include a workflow orchestrator 122 configured to coordinate and manage the workflow of processing of DNN models. As an example, the workflow orchestrator 122 can prioritize tasks on a first-come, first-served basis. The workflows can include model validation, deployment, monitoring, optimization of the DNN models, and the like. The MLOps processor 120 can communicate with the model operation tool stack 130 to perform the workflows.

For instance, the MLOps processor 120 can include, for example, at least one central processing unit (CPU), field-programmable gate array (FPGA) or any other circuitry that is configured to control and execute MLOps. The MLOps processor 120 can further include at least one memory devices such as read only memory (ROM), random access memory (RAM), electrically-erasable programmable read only memory (EEPROM), or other types of memory devices.

The model operation tool stack 130 can include tools for performing tasks for processing and validating DNN models. For instance, the model operation tool stack 130 can perform Post-Training Optimization (PTO), Quantization-Aware Training (QAT), optimization, compilation, and decryption of the models. The model operation tool stack 130 can communicate with the model storage 140 and the model registry 150.

PTO is a process that can reduce the computational load of models, and prepare the models for deployment on resource-constrained devices. QAT is a process that incorporates quantization techniques during the training of models to improve training efficiency. Optimization is a process that can improve computational efficiency and reduce resource consumption. Compilation is a process that can transform the models into formats that are compatible with the destination hardware platforms or environments. Decryption is a process that involves converting the encrypted model back into its original form so it can be loaded, processed, or executed.

The model storage 140 is configured to store a collection of encrypted machine learning models. The model storage 140 can protect proprietary, sensitive, or customer-submitted models from unauthorized access or tampering throughout their lifecycle. The model operation tool stack 130 can communicate with the model storage 140 to access the encrypted machine learning models.

The model registry 150 is configured to manage the machine learning model and the model transaction using the blockchain ledger. For instance, the model registry can implement the blockchain ledger to track interactions and transactions associated with the models. In this example, each transaction, such as registering, accessing, modifying, or deploying a model, can be recorded as an immutable blockchain entry. As an example, the model registry 150 is further configured to synchronize a state of the blockchain ledger periodically across the nodes in the permissioned blockchain network.

The system 100 can use a “proof of time” mechanism, based on a decentralized clock, ensuring these transactions'chronological integrity, and creating valid blockchain blocks that prevent tampering or unauthorized modifications.

The system 100 is a blockchain-integrated MLOps system that can ensure transparency, security, and trust in the management and processing of machine learning models. Every model processing step, such as registration, validation, or deployment, can be treated as a transaction that is recorded on a decentralized blockchain ledger. This blockchain ledger tracks all authorized interactions, providing an immutable and verifiable record of transactions. Moreover, the unauthorized interactions can be recorded by an invalid blockchain ledger for tracking purposes. By leveraging blockchain technology, the system 100 can build trust among stakeholders, ensuring the secure handling of proprietary models while promoting accountability and transparency.

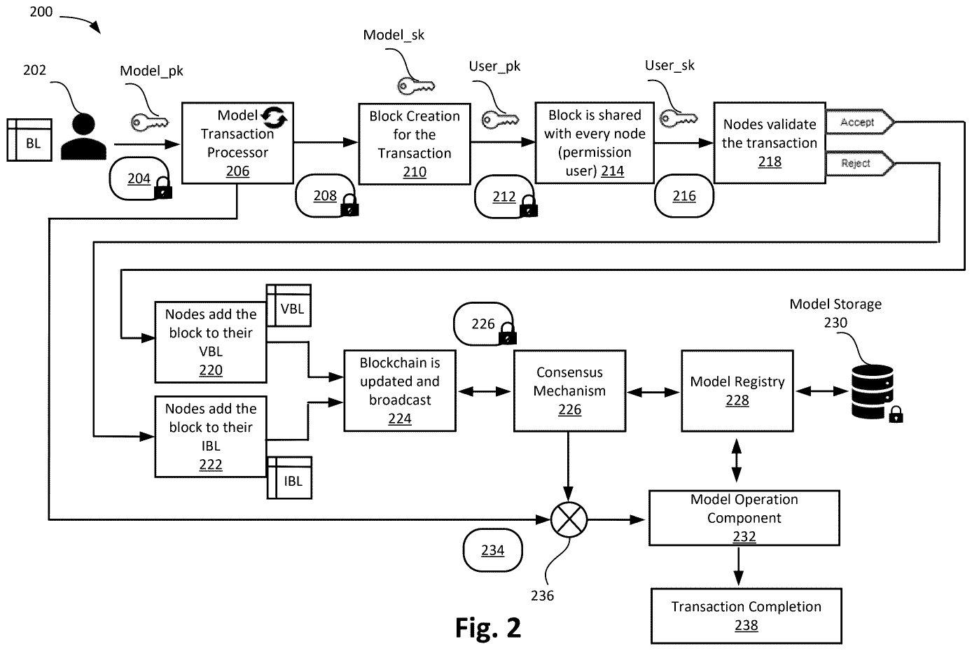

FIG. 2 is a diagram showing an example scenario 200 for implementing blockchain-secured machine learning model management according to an illustrative embodiment. For instance, scenario 200 can include operations and processes performed by the system 100 in FIG. 1 and components that perform tasks related to the blockchain ledger processing.

Referring to FIG. 2, a user 202 can log into the system 100 via an MLOps UI (which can be the MLOps UI 110 shown in FIG. 1). For instance, the MLOps UI can allow the UI for the user 202 to interact with the system 100. The MLOps UI can receive a request for operating a machine learning model from the user 202. The request can include a model transaction, a blockchain ledger BL associated with the machine learning model, and a model public key model_pk. The MLOps UI can include the authorization component 112 shown in FIG. 1. For instance, the blockchain ledger BL can include a valid blockchain ledger VBL and an invalid blockchain ledger IBL. The valid blockchain ledger VBL can hold valid transaction records. The invalid blockchain ledger IBL can hold invalid transaction records.

For instance, by default, the user can have access to the valid blockchain ledger VBL. Upon logging in and authenticating—e.g., through two-factor authentication or a similar mechanism—the user can securely encrypt their workload, which includes a model and associated operations to be performed. The encryption goes beyond just the model itself, and it can encompass the entire workload. Whether the workload involves registering the model, performing quantization, partitioning, running inference, or executing a series of operations, all such actions are encrypted as part of the workload.

The model public key model_pk and the encrypted workload 204 can be sent to a model transaction processor 206. The encrypted workload 204 can include the blockchain ledger BL and the model transaction(s) to be processed. For instance, when a new model is registered or an existing model is edited, a transaction occurs. Every action related to model management—whether it involves creating, updating, or modifying model records—can become part of the model registry. However, before the actions are officially incorporated into the model registry, a governance process will take place. The decision-making process is illustrated with respect to the subsequent operations, which outlines how governance is executed to validate and authorize these transactions.

For instance, the model transaction processor 206 can include, for example, at least one central processing unit (CPU), field-programmable gate array (FPGA) or any other circuitry that is configured to control and execute MLOps. The model transaction processor 206 can further include at least one memory devices such as read only memory (ROM), random access memory (RAM), electrically-erasable programmable read only memory (EEPROM), or other types of memory devices.

The model transaction processor 206 can receive the model public key model_pk and the encrypted workload 204. The model transaction processor 206 can verify the encrypted workload 204 based on the model public key model_pk and provide the verified encrypted model 208 for further processing. The verified encrypted model 208 can include the blockchain ledger BL and the model transaction(s) to be processed.

After the encrypted workload 204 is verified, the process can move to 210. At 210, a block for the model transaction(s) can be created using the model secret (private) key model_sk. For example, the newly created block can be hashed using the Secure Hash Algorithm 256 (SHA-256) algorithm. SHA-256 is a cryptographic hash function that converts any length of text into a fixed-size string of 256 bits. Note that other encryption algorithms can be used. The newly created block can be added to the blockchain ledger BL to generate an updated encrypted blockchain ledger 212. For instance, a “proof of time” method can be used, allowing creation of a valid block of transaction(s) based on a verifiable decentralized clock.

The process can move from 210 to 214. At 214, the updated encrypted blockchain ledger 212 and the user public key user_pk can be shared with every node (i.e., all the permissioned users). For example, a respective receiving node (i.e., a permissioned user) can decrypt the updated encrypted blockchain ledger 212 using the user secret (private) key user_sk to generate a decrypted blockchain ledger 216.

The process can move from 214 to 218. At 218, the respective receiving node (i.e., a permissioned user) can validate the model transaction(s) based on the decrypted blockchain ledger 216. For instance, the respective receiving node (i.e., a permissioned user) can perform the validation of the model transaction(s) either manually or based on pre-defined criteria. During the validation, the respective receiving node (i.e., a permissioned user) can either accept or reject the model transaction(s).

For instance, multiple permissioned users can be part of the permissioned blockchain network. When a new block is created, it is encrypted using the public keys of all permissioned users on the permissioned blockchain network. This encrypted block is then shared with every user within the permissioned blockchain network. Once a permissioned user receives the block, the user can decrypt it and update the user's version of the blockchain ledger. At this stage, the users can participate in a governance process, which may involve rule-based or manual mechanisms to validate transactions. Each user has the ability to review the transaction and either accept or reject it based on its legitimacy.

For instance, if validation is manual, permissioned users within the permissioned blockchain network can oversee and validate transactions. In a rule-based system, pre-programmed software can handle governance tasks, such as ensuring that only authorized users can perform actions on the models. For example, if a user is authorized only to run quantization on a particular model, the system 100 would enforce this rule at a granular level, which is a transaction level. If the user attempts to perform tasks outside her authorization, the system 100 can automatically flag or reject the action.

In certain cases, manual intervention might be required. For example, an operation team could review a list of pending transactions periodically—such as every 30 minutes, every hour, every day, etc.—and manually approve or reject the pending transactions. This manual governance is useful when the system 100 is not configured for instant responsiveness. Tasks such as quantization or model validation can take minutes to hours, depending on the complexity and the underlying cloud infrastructure. In a manual governance setup, operators can implement security and protocol compliance by actively monitoring and making approval decisions.

Alternatively, in a rule-based governance procedure, decisions to accept, reject, or flag transactions for manual review can be incorporated. This hybrid approach allows for flexibility, where automated rules handle straightforward cases, while flagged exceptions are escalated to human operators for careful evaluation.

If the model transaction(s) is accepted, the process can move from 218 to 220, where the newly created block can be added to the valid blockchain ledger VBL. If the model transaction(s) is rejected, the process can move from 218 to 222, where the newly created block can be added to the invalid blockchain ledger IBL.

For instance, if a transaction is accepted, it can be registered to the valid blockchain ledger VBL, and the transaction is added as a new block in the blockchain. On the other hand, if the transaction is rejected, it can be added as a new block in the invalid blockchain ledger IBL for tracking purposes. This approach ensures transparency and accountability, as the system 100 allows tracking of the user who initiated the request and the decision process associated with it. In implementations, users on the permissioned blockchain network are granted permission to perform specific actions, but if a user attempts to execute a transaction they are not authorized for, that action is still tracked. This ensures granular monitoring of unauthorized operations, right down to the transaction level. For instance, if a user is authorized only to perform quantization but attempts to carry out inference, their inference action will be rejected. This rejection, along with the corresponding notification, becomes an immutable part of the invalid blockchain ledger IBL.

Once the rejection or validation process is completed, the blockchain is updated and broadcast across the permissioned blockchain network. This update ensures that all participants in the permissioned network are immediately aware of the transaction status. For valid transactions, the updated blockchain reflects the authorization, allowing users to trace back the specific step or series of steps involved.

A consensus mechanism follows this process, which includes an admin-defined weighted threshold. The consensus mechanism can determine the level of approval required within the permissioned network to finalize the transaction. The approval can be based on manual or rule-based decision-making, ensuring transparency and accountability in the process.

Next, the process can move from 220 or 222 to 224. At 224, the system 100 can update the blockchain ledger BL and broadcast the updated blockchain BL to every node (i.e., all the permissioned users), such that all nodes can have a synchronized blockchain state.

Even with an invalid block, both the valid blockchain ledger VBL and the invalid blockchain ledger IBL need to proceed forward because the consensus mechanism requires a percentage of approval to finalize a decision. This is why even an invalid block is added to the blockchain ledger—it ensures transparency and allows for democratic decision-making among permissioned users.

If a transaction receives more rejections than acceptances during consensus, it is rejected. Notifications can be sent to the end user to inform them of the rejection, along with an explanation or instructions such as “Contact support for further assistance.” Once the rejection is finalized, the rejected block is not added to the valid blockchain ledger. This action happens before the block is propagated across the permissioned blockchain network, ensuring no node updates its ledger with the rejected transaction.

However, the rejected transaction is stored in the invalid block ledger IBL to maintain an audit trail. This allows for transparency during system audits by providing details of rejected transactions, including who participated in the rejection or approval and any associated summaries. While this information might not be directly valuable to the end user, it could be useful for monitoring or other purposes. If deemed necessary, access to this data could be provided selectively.

By maintaining both valid and invalid ledgers, the system tracks legitimate transactions while retaining a record of all rejected ones. This ensures a clear and auditable history for governance purposes.

The system 100 can have a consensus mechanism 226 configured to perform a consensus procedure. For instance, the consensus mechanism 226 can perform the consensus procedure such that the blockchain ledger BL is updated based on a weighted threshold defined by administrators. In the consensus procedure, the system 100 determines how many nodes within the permissioned blockchain network approved the model transaction(s) and how many nodes rejected the model transaction(s).

For instance, the consensus mechanism could require that a percentage e.g., 50% of the nodes (i.e., permissioned users) accept a transaction to approve the transaction. Note that the percentage of acceptance to approve the transaction can be set by administrators. Each node can define its own rules or use manual or rule-based decision-making processes to evaluate the transaction. For example, a first rule implemented by a first permissioned user differs from a second rule implemented by a second user, leading to conflicting decisions. In such a case, a higher authority (such as the consensus mechanism) or a designated user, would need to arbitrate and make the final decision. As an example, the consensus mechanism 226 can strive for a democratic consensus. For instance, if there are twenty permissioned users and five user approve the transaction while the other fifteen reject the transaction, the decision would align with the majority. In such a case, the five user approving the transaction are not necessarily deceptive actors, and they might simply have weaker rules or differing interpretations. In such an example, all users might have equal weight, and a simple majority rule could be applied.

Alternatively, weights can be assigned to the validation response of different users. For example, superusers could have a weight of two votes per approval, while basic users might have a weight of one vote, and another category of users could carry a weight of 0.5 votes. By implementing this weighted voting system, the decision-making/consensus process can incorporate both individual input and hierarchical influence, resulting in an aggregated score that determines whether a transaction is approved or rejected.

The consensus mechanism provides an additional layer of security, as it accounts for diverse decision-making criteria across all permissioned users.

Once consensus is achieved, the consensus mechanism enables access to the model processing stage. Specifically, the consensus authorizes an authenticated transaction trigger, which facilitates interaction with the model registry to retrieve the model. At this point, verified access is granted to the model operation component, allowing the user to utilize the model. On the other end, the encrypted raw model transaction is decrypted, allowing further operations or development activities. The raw model transaction receives permission, defining a series of steps expected by the user. This process transforms the transaction into an authorized one, which is then used as input for the blockchain ledger BL. Next, the model artifacts, including the model itself and associated data artifacts, are processed. Moreover, the required transactions can be executed.

The consensus mechanism 226 can communicate with a model registry 228. The model registry 228 is configured to store and manage the machine learning model and the model transaction. In this example, the model registry 228 can be open book, and every permissioned user in the permissioned blockchain network can have a copy of that book, and they'll synchronize those books in some sort of a periodic way. For instance, the accepted transaction(s) can trigger secure access to the model registry 228. The model registry 228 can perform core model registry activities. The model registry 228 can allow authenticated access for tasks such as reading/writing of the DNN models or further model development. The model registry 228 can communicate with the model storage 230 to securely store DNN models in an encrypted format, protecting the DNN models from unauthorized access and ensuring data confidentiality. Moreover, the model registry 228 can communicate with the model operation component 232.

The model storage 230 is configured to store a collection of encrypted DNN models. The model storage 230 can communicate with the core model registry to perform tasks on the DNN models.

The model operation component 232 can provide tools for model development. The model operation component 232, which can correspond to the model operation tool stack 130 in FIG. 1, plays can perform tasks such as graph partitioning, quantization, inference execution, profiling, or other necessary operations. Such tasks can be carried out sequentially or as required by the transaction. Once the operations are completed, the transaction is marked as finished and is recorded in the history of the model registry 228. For any subsequent transactions, the user must follow the same authentication process to initiate and complete new operations, ensuring a secure and structured workflow.

The model transaction processor 206 can also send the raw model transaction 234 to a mixer 236. The consensus mechanism 226 can also send the model transaction(s) permission to the mixer 236. The mixer 236 can take the raw model transaction 234 and the transaction(s) permission as inputs to generate an authenticated transaction(s), and feed the authenticated transaction(s) to the model operation component 232.

The process can move to transaction completion 238. At 238, the transaction processing can be completed. Once all steps, from transaction processing to blockchain consensus, are completed, the transaction completion stage is reached. At this stage, the valid blockchain ledger VBL reflects the validated transaction. Secure access to the DNN model is granted for authorized activities.

This framework integrates blockchain technology with advanced encryption and governance mechanisms to securely manage DNN model transactions, fostering trust and transparency among stakeholders while providing a verifiable and immutable record of all interactions with the DNN models. By leveraging a decentralized system, Scenario 200 illustrates how blockchain technology can enhance secure model management.

For example, asymmetric encryption is employed to secure transactions between the user interface (UI) and the blockchain. This ensures robust protection for data exchanged during these interactions. Additionally, symmetric encryption is utilized for communications between the model registry and the model store, providing an efficient and secure method for safeguarding data during storage and retrieval.

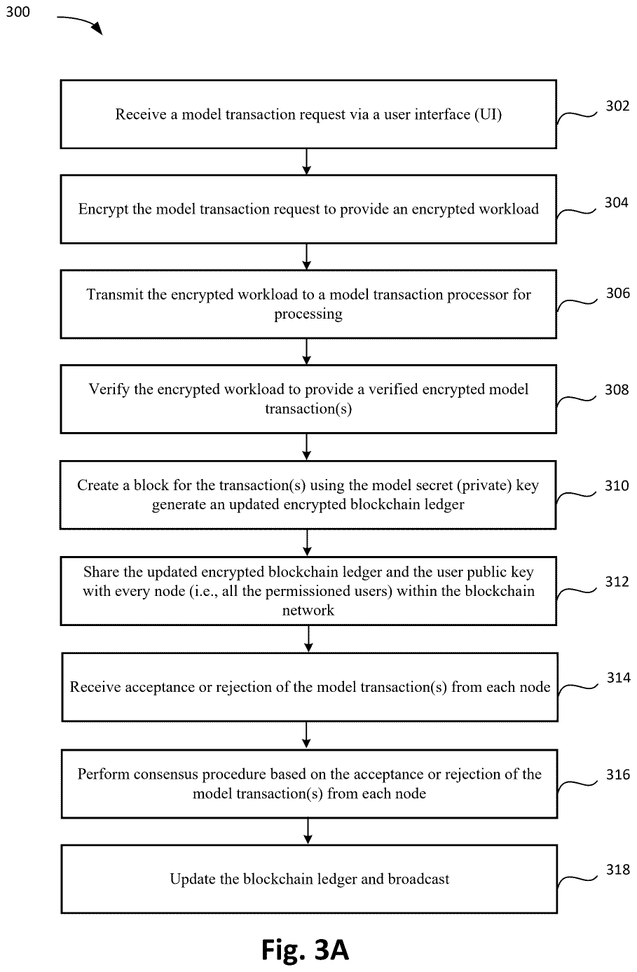

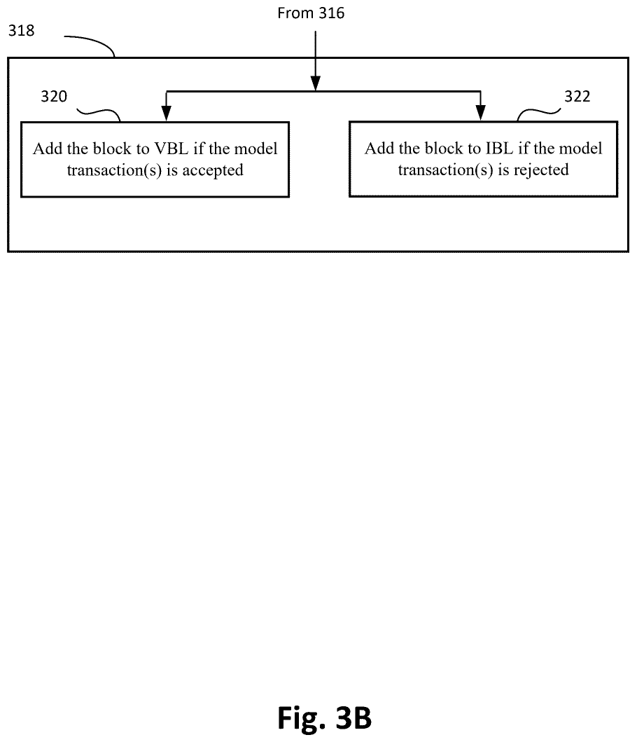

FIG. 3A and FIG. 3B illustrate a process 300 for implementing blockchain-secured machine learning model management according to an illustrative embodiment. The process 300 can be performed by one or more components of the system 100 shown in FIG. 1 and/or one or more components of the scenario 200 shown in FIG. 2.

Referring to FIG. 3A, process 300 can include one or more operations, actions, or functions as illustrated by one or more of blocks 302-314. Although illustrated as discrete blocks, various blocks may be divided into additional blocks, combined into fewer blocks, eliminated, performed in different order, or performed in parallel, depending on the desired implementation.

Process 300 can begin at block 302. At block 302, the system 100 can receive a model transaction request via a UI. For example, the UI can include the MLOps UI 110 shown in FIG. 1. A used can log into the system 100 through an authorization process, such as a two-factor authentication or a similar mechanism via the UI. Next, the user can send a transaction request to the system 100 via the UI. The user can have a blockchain ledger BL associated with the user.

Process 300 can proceed from block 302 to block 304. At block 304, the system 100 can encrypt the model transaction request to provide an encrypted workload. The encrypted workload can include the blockchain ledger associated with the user and the model transactions to be processed. As an example, the encryption of the workload can be encrypted using a model public key model_pk.

Process 300 can proceed from block 304 to block 306. At block 306, the system 100 can transmit the encrypted workload to a model transaction processor for processing.

Process 300 can proceed from block 306 to block 308. At block 308, the system 100 can verify the encrypted workload to provide a verified encrypted model transaction(s).

Process 300 can proceed from block 308 to block 310. At block 310, the system 100 can create a block for the model transaction(s) using the model secret (private) key model_sk to generate an updated encrypted blockchain ledger. For example, the newly created block can be hashed using the Secure Hash Algorithm 256 (SHA-256) algorithm.

Process 300 can proceed from block 310 to block 312. At block 312, the system 100 can share the updated encrypted blockchain ledger and the user public key user_pk with every node (i.e., all the permissioned users) within the permissioned blockchain network.

Process 300 can proceed from block 310 to block 312. At block 312, the system 100 can share the updated encrypted blockchain ledger and the user public key user_pk with every node (i.e., all the permissioned users) within the permissioned blockchain network.

The respective receiving node (i.e., a permissioned user) can validate the model transaction(s) based on the decrypted blockchain ledger 216. For instance, the respective receiving node (i.e., a permissioned user) can perform the validation of the model transaction(s) either manually or based on pre-defined criteria. During the validation, the respective receiving node (i.e., a permissioned user) can either accept or reject the model transaction(s).

Process 300 can proceed from block 312 to block 314. At block 314, the system 100 can receive acceptance or rejection of the model transaction(s) from each node.

Process 300 can proceed from block 314 to block 316. At block 316, the system 100 can perform consensus procedure based on the acceptance or rejection of the model transaction(s) from each node.

In the consensus procedure, the system 100 determines how many nodes within the permissioned blockchain network approved the model transaction(s) and how many nodes rejected the model transaction(s). For instance, the system 100 can approve the model transaction upon determining that a first percentage of the plurality of nodes accepts the model transaction. On the other hand the system 100 can reject the model transaction upon determining that a second percentage of the plurality of nodes rejects the model transaction. For example, the consensus mechanism could require that a percentage e.g., 50% of the nodes (i.e., permissioned users) accept a transaction to approve the transaction. Additional details of the consensus procedure are provided throughout this disclosure and are not repeated here.

Process 300 can proceed from block 316 to block 318. At block 318, the system 100 can update the blockchain ledger and broadcast the updated blockchain ledger to each node within the permissioned blockchain network.

Referring to FIG. 3B, process 300 can proceed from block 316 to block 318 or block 322. At block 318, the system 100 can add the block to VBL if the model transaction(s) is accepted. At block 322, the system 100 can add the block to IBL if the model transaction(s) is rejected. Additional details of adding the block to VBL and IBL are provided throughout this disclosure, and are not repeated herein.

The operations described herein for implementing blockchain-secured machine learning operations can be performed by hardware components configured to execute machine-readable instructions. Such hardware components may include, but are not limited to, processors, central processing units (CPUs), graphical processing units (GPUs), application-specific integrated circuits (ASICs), system-on-chip (SoC) devices, field-programmable gate arrays (FPGAs), and other computing devices capable of executing the operations. These components can be integrated within or connected to the system to process the received model transaction requests, encrypt and verify data, create and update blockchain ledgers, and perform consensus procedures across a permissioned blockchain network.

The platform, controller, or processor described herein can include one or more memory devices, such as random-access memory (RAM), read-only memory (ROM), flash memory, or other non-transitory computer-readable storage media. These memory devices can store machine-readable instructions, such as program code, that are executable by the processor to perform the steps, functions, or blocks described in the flowcharts or processes disclosed herein. For example, the memory devices may store instructions to enable the processor to execute operations for receiving model transaction requests, encrypting and verifying data, creating and sharing encrypted blockchain ledgers, performing consensus procedures, updating the blockchain, or the like. These instructions may be organized into modules or components that correspond to the functional blocks illustrated in the FIG. 1 and FIG. 2 and described in this disclosure.

### EXAMPLES

1. A system for implementing blockchain-secured machine learning model management, the system comprising: a Machine Learning Operations (MLOps) user interface (UI) configured to allow a user to interact with the system and receive a request for operating a machine learning model, wherein the request comprises a model transaction and blockchain ledger; an MLOps processor communicatively connected to the MLOps UI, the MLOps processor being configured to manage the machine learning model and to execute workflows associated with the model transaction; and a model operation tool stack communicatively connected to the MLOps processor, the model operation tool stack being configured to perform tasks for operating the machine learning model; a model storage communicatively connected to the model operation tool stack, the model storage being configured to store encrypted machine-learning models; and a model registry communicatively connected to the model operation tool stack, the model registry being configured to manage the machine learning model and the model transaction using the blockchain ledger.

Clause 2. The system of clause 1 wherein the MLOps UI comprises an authorization component configured to verify an identity of the user and authenticate access to the machine learning model by the user.

Clause 3. The system of clause 1 or 2 wherein the MLOps processor comprises a workflow orchestrator configured to coordinate and prioritize workflows.

Clause 4. The system of any one of clauses 1-3 wherein the workflow orchestrator prioritizes the workflows on a first-come, first-served basis.

Clause 5. The system of any one of clauses 1-4 wherein the machine learning model is a deep neural network (DNN) model.

Clause 6. The system of any one of clauses 1-5 wherein the blockchain ledger comprises a valid blockchain ledger and an invalid blockchain ledger.

Clause 7. A system for implementing blockchain-secured machine learning model management, the system comprising: a Machine Learning Operations (MLOps) user interface (UI) configured to: allow a user to interact with the system and receive a request for operating a machine learning model, wherein the request comprises a model transaction and blockchain ledger associated with the machine learning model; and provide an encrypted workload based on the request for operating the machine learning model; a model transaction processor communicatively connected to the MLOps UI, the model transaction processor being configured to: verify the encrypted workload based on a model public key to generate a verified encrypted model; and create a block for the model transaction using a model secret key to provide a created block; a consensus mechanism configured to: broadcast the created block to a plurality of nodes in a permissioned blockchain network; receive a plurality of validation responses regarding the model transaction from the plurality of nodes; and determine a consensus based on the validation responses; a model registry communicatively connected to the consensus mechanism, the model registry being configured to manage the machine learning model and the model transaction using the blockchain ledger; and a model storage communicatively connected to the model registry, the model storage being configured to store the machine learning model in an encrypted format.

Clause 8. The system of clause 7, wherein the consensus is determined based on a weighted threshold.

Clause 9. The system of clause 7 or 8, the consensus mechanism is configured to assign a weight to a respective validation response from a respective node of the plurality of nodes.

Clause 10. The system of any one of clauses 7-9, wherein the blockchain ledger comprises a valid blockchain ledger and an invalid blockchain ledger.

Clause 11. The system of any one of clauses 7-10, wherein the model registry is further configured to add the created block to the valid blockchain ledger based on the consensus.

Clause 12. The system of any one of clauses 7-11, wherein the model registry is further configured to add the created block to the invalid blockchain ledger based on the consensus.

Clause 13. The system of any one of clauses 7-12 wherein a respective node of the plurality of nodes is configured to determine a respective validation response based on rules or manually.

Clause 14. The system of any one of clauses 7-13, wherein the consensus mechanism is configured to assign a weight with respect to the validation response of a respective node of the plurality of nodes.

Clause 15. The system of any one of clauses 7-14, wherein the model registry is further configured to synchronize a state of the blockchain ledger periodically across the plurality of nodes in the permissioned blockchain network.

Clause 16. The system of any one of clauses 7-15 further comprising a model operation component communicatively connected to the model registry, the model operation component comprising tools for performing quantization, graph partitioning, inference execution, and/or profiling of the machine learning model.

Clause 17. A method for implementing blockchain-secured machine learning model management, the method comprising: receiving, via a user interface (UI), a request for operating a machine learning model, wherein the request comprises a model transaction and blockchain ledger associated with the machine learning model; encrypting the request using a model public key to generate an encrypted workload; transmitting the encrypted workload to a model transaction processor; verifying, by the model transaction processor, the encrypted workload to generate a verified encrypted model transaction; creating a block based on the verified encrypted model transaction to provide an updated encrypted blockchain ledger; sending the updated encrypted blockchain ledger and a user public key with a plurality of nodes in a permissioned blockchain network; receiving a plurality of validation responses from the plurality of nodes, each validation response indicating an acceptance or a rejection of the model transaction; performing a consensus procedure based on the plurality of validation responses to determine a consensus result; and updating the blockchain ledger based on the consensus result and broadcasting an updated blockchain ledger to the plurality of nodes in the permissioned blockchain network.

Clause 18. The method of clause 17 wherein the block is encrypted using a secure hash algorithm and a model secret key.

Clause 19. The method of clause 17 or 18 wherein performing the consensus procedure based on the plurality of validation responses comprises: approving the model transaction upon determining that a first percentage of the plurality of nodes accepts the model transaction; and rejecting the model transaction upon determining that a second percentage of the plurality of nodes rejects the model transaction.

Clause 20. The method of any one of clauses 17-19, wherein updating the blockchain ledger based on the consensus result comprises: adding the block to a verified blockchain ledger if the model transaction is approved; and adding the block to a rejected blockchain ledger if the model transaction is rejected.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting to the present disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the embodiments in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. A system for implementing blockchain-secured machine learning model management, the system comprising:
a Machine Learning Operations (MLOps) user interface (UI) configured to allow a user to interact with the system and receive a request for operating a machine learning model, wherein the request comprises a model transaction and blockchain ledger;
an MLOps processor communicatively connected to the MLOps UI, the MLOps processor being configured to manage the machine learning model and to execute workflows associated with the model transaction; and
a model operation tool stack communicatively connected to the MLOps processor, the model operation tool stack being configured to perform tasks for operating the machine learning model;
a model storage communicatively connected to the model operation tool stack, the model storage being configured to store encrypted machine-learning models; and
a model registry communicatively connected to the model operation tool stack, the model registry being configured to manage the machine learning model and the model transaction using the blockchain ledger.

2. The system of claim 1 wherein the MLOps UI comprises an authorization component configured to verify an identity of the user and authenticate access to the machine learning model by the user.

3. The system of claim 1 wherein the MLOps processor comprises a workflow orchestrator configured to coordinate and prioritize workflows.

4. The system of claim 3 wherein the workflow orchestrator prioritizes the workflows on a first-come, first-served basis.

5. The system of claim 1 wherein the machine learning model is a deep neural network (DNN) model.

6. The system of claim 1 wherein the blockchain ledger comprises a valid blockchain ledger and an invalid blockchain ledger.

7. A system for implementing blockchain-secured machine learning model management, the system comprising:
a Machine Learning Operations (MLOps) user interface (UI) configured to:
allow a user to interact with the system and receive a request for operating a machine learning model, wherein the request comprises a model transaction and blockchain ledger associated with the machine learning model; and
provide an encrypted workload based on the request for operating the machine learning model;
a model transaction processor communicatively connected to the MLOps UI, the model transaction processor being configured to:
verify the encrypted workload based on a model public key to generate a verified encrypted model; and
create a block for the model transaction using a model secret key to provide a created block;
a consensus mechanism configured to:
broadcast the created block to a plurality of nodes in a permissioned blockchain network;
receive a plurality of validation responses regarding the model transaction from the plurality of nodes; and
determine a consensus based on the validation responses;
a model registry communicatively connected to the consensus mechanism, the model registry being configured to manage the machine learning model and the model transaction using the blockchain ledger; and
a model storage communicatively connected to the model registry, the model storage being configured to store the machine learning model in an encrypted format.

8. The system of claim 7, wherein the consensus is determined based on a weighted threshold.

9. The system of claim 7, the consensus mechanism is configured to assign a weight to a respective validation response from a respective node of the plurality of nodes.

10. The system of claim 7, wherein the blockchain ledger comprises a valid blockchain ledger and an invalid blockchain ledger.

11. The system of claim 10, wherein the model registry is further configured to add the created block to the valid blockchain ledger based on the consensus.

12. The system of claim 10, wherein the model registry is further configured to add the created block to the invalid blockchain ledger based on the consensus.

13. The system of claim 7 wherein a respective node of the plurality of nodes is configured to determine a respective validation response based on rules or manually.

14. The system of claim 7, wherein the consensus mechanism is configured to assign a weight with respect to the validation response of a respective node of the plurality of nodes.

15. The system of claim 7, wherein the model registry is further configured to synchronize a state of the blockchain ledger periodically across the plurality of nodes in the permissioned blockchain network.

16. The system of claim 7 further comprising a model operation component communicatively connected to the model registry, the model operation component comprising tools for performing quantization, graph partitioning, inference execution, and/or profiling of the machine learning model.

17. A method for implementing blockchain-secured machine learning model management, the method comprising:
receiving, via a user interface (UI), a request for operating a machine learning model, wherein the request comprises a model transaction and blockchain ledger associated with the machine learning model;
encrypting the request using a model public key to generate an encrypted workload;
transmitting the encrypted workload to a model transaction processor;
verifying, by the model transaction processor, the encrypted workload to generate a verified encrypted model transaction;
creating a block based on the verified encrypted model transaction to provide an updated encrypted blockchain ledger;
sending the updated encrypted blockchain ledger and a user public key with a plurality of nodes in a permissioned blockchain network;
receiving a plurality of validation responses from the plurality of nodes, each validation response indicating an acceptance or a rejection of the model transaction;
performing a consensus procedure based on the plurality of validation responses to determine a consensus result; and
updating the blockchain ledger based on the consensus result and broadcasting an updated blockchain ledger to the plurality of nodes in the permissioned blockchain network.

18. The method of claim 17 wherein the block is encrypted using a secure hash algorithm and a model secret key.

19. The method of claim 17 wherein performing the consensus procedure based on the plurality of validation responses comprises:
approving the model transaction upon determining that a first percentage of the plurality of nodes accepts the model transaction; and
rejecting the model transaction upon determining that a second percentage of the plurality of nodes rejects the model transaction.

20. The method of claim 19 wherein updating the blockchain ledger based on the consensus result comprises:
adding the block to a verified blockchain ledger if the model transaction is approved; and
adding the block to a rejected blockchain ledger if the model transaction is rejected.
